(19) United States
(12) Patent Application Publication
(10) Pub. No.: US 2022/0066522 A1
(43) Pub. Date: Mar. 3, 2022

(54) FLEXIBLE DISPLAY PANEL AND DISPLAY APPARATUS

(71) Applicant: SHENZHEN ROYOLE TECHNOLOGIES CO., LTD., Shenzhen (CN)

(72) Inventors: Weihua JIA, Shenzhen (CN); Tsu Chiang Chang, Shenzhen (CN); Changming Qiu, Shenzhen (CN)

(21) Appl. No.: 17/412,627

(22) Filed: Aug. 26, 2021

(30) Foreign Application Priority Data
Aug. 26, 2020 (CN) 202010872457.7

(51) Int. Cl. G06F 1/18; G09F 9/30; G06F 1/16

(52) U.S. Cl. CPC G06F 1/189; G06F 1/1652; G09F 9/301

(57) ABSTRACT

Embodiments of the present disclosure provide a flexible display panel and a display apparatus, and relate to the field of flexible display technologies. The flexible display panel includes a bent region, the bent region includes a trace layer, and the trace layer is provided with a wire. The wire includes a first bent part and a second bent part adjacent to the first bent part in an extension direction of a bending parallel line, and the second bent part and the first bent part are located on different bending parallel lines, where the bending parallel lines are parallel to a bending axis of the bent region. The flexible display panel can improve bending resistance of the wire, reduce a risk of wire fracture during bending of the bent region, ensure a signal transmission effect, and effectively alleviate the problem of poor display.

### TECHNICAL FIELD

The present disclosure relates to the field of flexible display technologies, and in particular, to a flexible display panel and a display apparatus.

### BACKGROUND ART

With an increasing demand for display apparatuses, requirements for display appearance are becoming increasingly high. Especially for mobile display products like mobile phones, more attention has been paid to a display effect of mobile phones with a narrow bezel and a high screen-to-body ratio, i.e., a smaller size of a non-display region around a display region indicates a better display effect.

A technology of bending a flexible backplane backward among related technologies enables a lower bezel of an original rigid display panel to become smaller by arranging a bent region below the display region, where a signal trace in this region bends with the bent region. However, in the related technologies, the bending resistance of a metal trace is poor, and a risk of metal trace fracture in the bent region is high. The fracture of the metal trace causes signal transmission failure and poor display.

### SUMMARY OF THE INVENTION

An objective of the present disclosure is to provide a flexible display panel and a display apparatus, which can improve bending resistance of a wire, reduce a risk of wire fracture during bending, ensure a signal transmission effect, and alleviate poor display.

Embodiments of the present disclosure may be implemented as follows:

According to a first aspect, an embodiment of the present disclosure provides a flexible display panel, including a bent region, where the bent region includes a trace layer, the trace layer is provided with a wire, and the wire includes a first bent part and a second bent part adjacent to the first bent part in an extension direction of a bending parallel line, and the second bent part and the first bent part are located on different bending parallel lines, where the bending parallel lines are parallel to a bending axis of the bent region; and/or, the wire further includes a third bent part adjacent to the first bent part in an extension direction of a bending vertical line, and the third bent part and the first bent part are located on different bending vertical lines, where the bending vertical lines are perpendicular to the bending axis of the bent region.

According to a second aspect, an embodiment of the present disclosure provides a display apparatus including a flexible display panel, where the flexible display panel includes a bent region, the bent region includes a trace layer, the trace layer is provided with a wire, and the wire includes a first bent part and a second bent part adjacent to the first bent part in an extension direction of a bending parallel line, and the second bent part and the first bent part are located on different bending parallel lines, where the bending parallel lines are parallel to a bending axis of the bent region; and/or, the wire further includes a third bent part adjacent to the first bent part in an extension direction of a bending vertical line, and the third bent part and the first bent part are located on different bending vertical lines, where the bending vertical lines are perpendicular to the bending axis of the bent region.

The flexible display panel and the display apparatus provided in the embodiments of the present disclosure have the following beneficial effects: Because the second bent part and the first bent part are located on different bending parallel lines, a stress on the same bending parallel line during bending of the bent region is reduced, and bending resistance of the wire is improved; and even if one of the first bent part and the second bent part fractures, a crack does not easily extend to the other one along a substrate material, thereby effectively lowering the probability that both the first bent part and the second bent part are fractured. Because the third bent part and the first bent part are located on different bending vertical lines, a stress on the same bending vertical line during bending of the bent region is reduced, and bending resistance of the wire is improved; and even if one of the first bent part and the third bent part fractures, a crack does not easily extend to the other one along a substrate material, thereby effectively lowering the probability that both the first bent part and the third bent part are fractured. Therefore, the flexible display panel and the display apparatus can reduce a risk of wire fracture during bending of the bent region, ensure a signal transmission effect, and alleviate poor display.

### BRIEF DESCRIPTION OF THE DRAWINGS

To describe the technical solutions in the embodiments of the present disclosure more clearly, the following briefly describes the accompanying drawings required in the embodiments. It should be understood that the following accompanying drawings show merely some embodiments of the present disclosure and thus should not be considered as a limitation on the scope, and a person of ordinary skill in the art may still derive other related accompanying drawings from these accompanying drawings without creative efforts.

FIG. 1 is a schematic structural diagram illustrating a flexible display panel according to an embodiment of the present disclosure;

FIG. 2 is a schematic structural diagram illustrating a bent region of a flexible display panel according to an embodiment of the present disclosure;

FIG. 3 is a schematic structural diagram illustrating a wire of a flexible display panel according to a first embodiment of the present disclosure;

FIG. 4 is a schematic structural diagram illustrating a wire of a flexible display panel according to a second embodiment of the present disclosure;

FIG. 5 is a schematic structural diagram illustrating a wire of a flexible display panel according to a third embodiment of the present disclosure;

FIG. 6 is a schematic structural diagram illustrating a wire of a flexible display panel according to a fourth embodiment of the present disclosure;

FIG. 7 is a schematic structural diagram illustrating a wire of a flexible display panel according to a fifth embodiment of the present disclosure;

FIG. 8 is a schematic structural diagram illustrating a wire of a flexible display panel according to a sixth embodiment of the present disclosure;

FIG. 9 is a schematic structural diagram illustrating a wire of a flexible display panel according to a seventh embodiment of the present disclosure; and

FIG. 10 is a schematic structural diagram illustrating a wire of a flexible display panel according to an eighth embodiment of the present disclosure.

Reference numerals: 1: flexible display panel; 20: display region; 10: bent region; 11: substrate; 12: trace layer; 100: wire; 111: first bent part; 112: second bent part; 113: third bent part; 114: bending parallel line; 115: bending vertical line; 116: first wire; 117: second wire; 120: bending unit; 121: first bent section; 122: second bent section; 123: first bending unit; 124: second bending unit; 125: third bending unit; 1251: third bent section; 1252: fourth bent section; 126: fourth bending unit; 127: fifth bending unit; 128: sixth bending unit; 1261: fifth bent section; 1262: sixth bent section; 131: first parallelogram wire frame; 132: second parallelogram wire frame; 133: third parallelogram wire frame; 134: fourth parallelogram wire frame; 135: fifth parallelogram wire frame; 136: sixth parallelogram wire frame; 137: seventh parallelogram wire frame; 138: eighth parallelogram wire frame; 139: ninth parallelogram wire frame; 1310: tenth parallelogram wire frame; 141: first bending unit group; 142: second bending unit group.

### DETAILED DESCRIPTION OF THE INVENTION

To make the objectives, technical solutions and advantages of the embodiments of the present disclosure clearer, the following clearly and completely describes the technical solutions in the embodiments of the present disclosure with reference to accompanying drawings in the embodiments of the present disclosure. Apparently, the described embodiments are some rather than all of the embodiments. Components of the embodiments of the present disclosure generally described and illustrated in the accompanying drawings herein may be arranged and designed in various different configurations.

Therefore, the following detailed description of the embodiments of the present disclosure provided in the accompanying drawings is not intended to limit the claimed scope of the present disclosure, but merely represents selected embodiments of the present disclosure. All other embodiments obtained by a person of ordinary skill in the art based on the embodiments of the present disclosure without creative efforts shall fall within the protection scope of the present disclosure.

It should be noted that similar reference numerals and letters indicate similar terms in the following accompanying drawings. Therefore, once a certain term is defined in one accompanying drawing, it does not need to be further defined and explained in the subsequent accompanying drawings.

In the description of the present disclosure, it should be noted that orientations or position relationships indicated by terms “upper”, “lower”, “inner”, “outer”, etc. are based on the orientation or position relationships shown in the accompanying drawings, or the orientation or position relationships shown when products of the present disclosure are usually placed in use, and these terms are just used to facilitate description of the present disclosure and simplify the description, but not to indicate or imply that the mentioned device or elements must have a specific orientation and must be established and operated in a specific orientation, and thus, these terms cannot be understood as a limitation to the present disclosure.

In addition, the terms such as “first” and “second” are merely used to distinguish between descriptions and cannot be understood as indicating or implying relative importance.

It should be noted that features in the embodiments of the present disclosure can be combined with each other provided that no conflict occurs.

In related technologies, a flexible display panel is provided with a bent region below a display region, a signal trace is arranged in the bent region to be electrically connected to an external circuit, and the signal trace in the bent region bends with the bent region. However, in the related technologies, the bending resistance of a metal trace is poor, and a risk of metal trace fracture in the bent region is high. The fracture of the metal trace causes signal transmission failure and poor display.

The designer of the present disclosure found in research that in related technologies, bending positions of different metal traces in the bent region are arranged on the same parallel line parallel to a bending axis or arranged on the same vertical line perpendicular to the bending axis, and a stress is concentrated on the same parallel line or the same vertical line during bending of the bent region. When a fracture occurs in a bend position of a certain trace, a crack easily extends along a substrate material and along the same parallel line or the same vertical line, and then one or more metal traces fracture, resulting in signal transmission failure and poor display. To solve the above-mentioned technical problems, embodiments of the present disclosure provide a flexible display panel and a display apparatus, which can improve bending resistance of metal traces and effectively alleviate the problem of metal trace fracture.

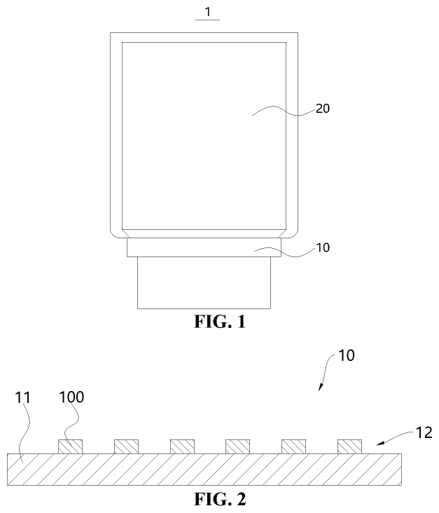

Referring to FIG. 1 and FIG. 2, an embodiment of the present disclosure provides a flexible display panel 1. The flexible display panel 1 can be applied to a display apparatus, such as a mobile phone or another terminal display device. The flexible display panel 1 includes a display region 20 and a bent region 10 located at an end of the display region 20, where the bent region 10 includes a substrate 11 and a trace layer 12 formed on the substrate 11. A wire 100 is included in the trace layer 12. The wire 100 is a metal trace. Optionally, the wire 100 may be a signal line or a power cord.

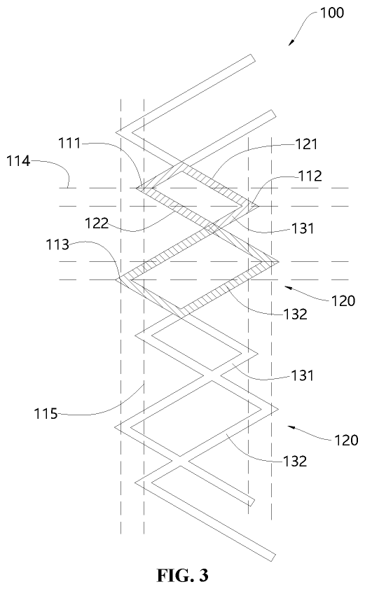

Referring to FIG. 3, the wire 100 includes a first bent part 111 and a second bent part 112 adjacent to the first bent part 111 in an extension direction of a bending parallel line 114. The second bent part 112 and the first bent part 111 are located on different bending parallel lines 114, where the bending parallel lines 114 are parallel to a bending axis of the bent region 10; and/or the wire 100 includes a first bent part 111 and a third bent part 113 adjacent to the first bent part 111 in an extension direction of a bending vertical line 115. The third bent part 113 and the first bent part 111 are located on different bending vertical lines 115, where the bending vertical lines 115 are perpendicular to the bending axis of the bent region 10.

It should be noted that the wire 100 is corrugated, and the first bent part 111, the second bent part 112 and the third bent part 113 are all bending positions of the wire 100, i.e., the wire 100 bends at the first bent part 111, the second bent part 112 and the second bent part 113. When the wire 100 is bent, the bending positions of the wire 100 bears a relatively large stress. Therefore, the first bent part 111, the second bent part 112 and the third bent part 113 are all parts that bear a large bending stress when the wire 100 is bent.

In addition, the bending axis is an axis around which the wire 100 rotates when the wire 100 is bent. In the embodiment of the present disclosure, optionally, the bending axis may be parallel to a width direction of the display region 20. The bending parallel line 114 is a line parallel to the bending axis in the bent region 10, and the bending vertical line 115 is a line perpendicular to the bending axis in the bent region 10. In the embodiment of the present disclosure, the extension direction of the bending parallel line 114 refers to the extension direction of the bending parallel line 114 as viewed from the wire 100 as a whole, and the extension direction of the bending perpendicular line 115 refers to the extension direction of the bending vertical line 115 as viewed from the wire 100 as a whole.

In addition, it should be noted that the above-mentioned “and/or” means that in the wire 100, only the second bent part 112 and the first bent part 111 may be located on different bending parallel lines 114, or only the third bent part 113 and the first bent part 111 may be located on different bending vertical lines 115, or both of the above-mentioned situations may occur simultaneously.

It should also be noted that the first bent part 111 and the second bent part 112 may be on the same wire 100 or different wires 100. Similarly, the first bent part 111 and the third bent part 113 may be on the same wire 100 or different wires 100. In addition, the first bent part 111 and the second bent part 112 may be at the same trace layer 12 or different trace layers 12; and the first bent part 111 and the third bent part 113 may be at the same trace layer 12 or different trace layers 12.

When the first bent part 111 and the second bent part 112 are on the same wire 100, the wire 100 may include multiple bending units 120 connected in sequence, each of the bending units 120 may include one or more closed wire frame structures, and the first bent part 111 and the second bent part 112 are arranged on the same wire frame structure. Due to the closed wire frame structure, part of a stress generated when the bent region 10 is bent can be absorbed through deformation. Moreover, a double conductive channel or a redundant conductive channel is present, so that even if some line sections fracture, the signal transmission is still unaffected because of the redundant conductive channel. Optionally, the first bent part 111 and the second bent part 112 are two parts of the wire frame structure that bear the largest bending stress, that is, the first bent part 111 is one of the parts of the wire frame structure that bear the largest bending stress; in the direction of the bending parallel line 114, the other part of the wire frame structure that bears the largest bending stress is the second bent part 112, and the first bent part 111 and the second bent part 112 are on different bending parallel lines 114.

When the first bent part 111 and the third bent part 113 are on the same wire 100, the first bent part 111 and the third bent part 113 are located on the same side of the wire 100. It should be noted that the wire 100 is corrugated, but the wire 100 as a whole may have two sides symmetrical along a vertical center line of the wire 100, and the first bent part 111 and the third bent part 113 are located on the same side. The vertical center line is substantially parallel to the bending vertical line. The first bent part 111 is a part of the wire 100 that bears a large bending stress. In the extension direction of the bending vertical line 115, the third bent part 113 is another part that is adjacent to the first bent part 111 and bears a large bending stress.

When the first bent part 111 and the second bent part 112 are on different wires 100, the first bent part 111 is a part of one of the wires 100 that bears a large bending stress. In the extension direction of the bending vertical line 115, the second bent part 112 is a part of the other wire 100 that is adjacent to the first bent part 111 and bears a large bending stress.

When the first bent part 111 and the second bent part 112 are on different trace layers 12, the first bent part 111 is a part of a wire 100 at one of the trace layers 12 that bears a large bending stress. Projections of the first bent part 111 and the second bent part 112 on a surface of the bent region 10 are adjacent to each other. Moreover, in the direction of the bending parallel line 114, the second bent part 112 is a part of another wire 100 at the other trace layer 12 that bears a large bending stress.

In conclusion, because the second bent part 112 and the first bent part 111 are located on different bending parallel lines 114, a stress on the same bending parallel line 114 during bending of the bent region 10 is reduced, and bending resistance of the wire 100 is improved; and even if one of the first bent part 111 and the second bent part 112 fractures, a crack does not easily extend to the other one along a material of the substrate 11, thereby effectively lowering the probability that both the first bent part 111 and the second bent part 112 are fractured. Because the third bent part 113 and the first bent part 111 are located on different bending vertical lines 115, a stress on the same bending vertical line 115 during bending of the bent region 10 is reduced, and bending resistance of the wire 100 is improved; and even if one of the first bent part 111 and the third bent part 113 fractures, a crack does not easily extend to the other one along the material of the substrate 11, thereby effectively lowering the probability that both the first bent part 111 and the third bent part 113 are fractured. Therefore, the flexible display panel and the display apparatus can reduce a risk of fracture of the wire 100 during bending of the bent region 10, ensure a signal transmission effect, and effectively alleviate poor display.

### First Embodiment

Referring to FIG. 3, a wire 100 of a flexible display panel 1 provided in this embodiment includes multiple bending units 120 connected in sequence (in FIG. 3, one of the bending units 120 is indicated by shading). Each bending unit 120 is provided with a first bent part 111, a second bent part 112 and a third bent part 113. The first bent part 111, the second bent part 112 and the third bent part 113 are located on the same wire 100. The second bent part 112 is adjacent to the first bent part 111 in an extension direction of a bending parallel line 114, and the second bent part 112 and the first bent part 111 are located on different bending parallel lines 114, where the bending parallel lines 114 are parallel to a bending axis of a bent region 10. The third bent part 113 is adjacent to the first bent part 111 in an extension direction of a bending vertical line 115, and the third bent part 113 and the first bent part 111 are located on different bending vertical lines 115, where the bending vertical lines 115 are perpendicular to the bending axis of the bent region 10.

It should be noted that each bending unit 120 may include one or more closed polygonal wire frame structures. The first bent part 111 and the second bent part 112 are arranged on the same polygonal wire frame structure. In this embodiment, each bending unit 120 may include an unequal parallelogram, and the first bent part 111 and the second bent part 112 are located at two opposite corners of the unequal parallelogram in the direction of the bending parallel line respectively. The first bent part 111 and the second bent part 112 are two parts of the unequal parallelogram that bear the largest bending stress, i.e., the first bent part 111 is one of the parts of the unequal parallelogram that bear the largest bending stress; in the direction of the bending parallel line 114, the other part of the unequal parallelogram that bears the largest bending stress is the second bent part 112, and the first bent part 111 and the second bent part 112 are on different bending parallel lines 114.

It should be noted that through simulation, it is found that after the wire 100 is bent, positions of the same unequal parallelogram that have the largest strain are two opposite corners of the unequal parallelogram in the direction of the bending parallel line, i.e., the first bent part 111 and the second bent part 112 bear the largest bending stress, and a joint between the unequal parallelogram and an adjacent wire frame structure has a strain smaller than that of the strain at each of the opposite corners in the direction of the bending parallel line.

Optionally, the unequal parallelogram includes a first bent section 121 and a second bent section 122. A joint between one end of the first bent section 121 and one end of the second bent section 122 is bent to form one of the opposite corners of the unequal parallelogram. It should be understood that the first bent part 111 is located at the aforementioned opposite corner. A joint between the other end of the first bent section 121 and the other end of the second bent section 122 is bent to form the other opposite corner of the unequal parallelogram. It should be understood that the second bent part 112 is located at the other aforementioned opposite corner. In this way, the first bent part 111 and the second bent part 112 are formed at two opposite corners formed between the first bent section 121 and the second bent section 122, respectively, and are formed on different bending parallel lines 114. When bending occurs, the stress on the same bending parallel line 114 can be reduced, thereby reducing a risk of fracture of the wire 100 on the same bending parallel line 114.

In this embodiment, the first bent section 121 and the second bent section 122 each are in a shape of a fold line, the first bent section 121 is substantially in an inverted-V shape, the second bent section 122 is substantially in a V shape, and the two are connected to form the wire frame structure of the unequal parallelogram. That is, the unequal parallelogram is provided with a through hole, and the through hole is in a shape of an unequal parallelogram. It should be noted that in other embodiments of the present disclosure, the first bent section 121 and the second bent section 122 each may be in an arc shape, and openings of the two are arranged oppositely and connected to form a circular wire frame structure or an oval structure, that is, the through hole of the wire frame structure may be circular or oval.

In a modified embodiment, each bending unit 120 includes a first parallelogram wire frame 131 and a second parallelogram wire frame 132 that are different in size and connected to each other. The first parallelogram wire frame 131 is the aforementioned unequal parallelogram, the first bent part 111 and the second bent part 112 are located at two opposite corners of the unequal parallelogram in the direction of the bending parallel line respectively, and the third bent part 113 is located at the second parallelogram wire frame. In this embodiment, optionally, an area of the first parallelogram wire frame 131 is smaller than an area of the second parallelogram wire frame 132.

It should be noted that the first parallelogram wire frame 131 is connected to the second parallelogram wire frame 132 on each bending unit 120 at an opposite corner on the bending vertical line. The second parallelogram wire frame 132 on one bending unit 120 is connected to the first parallelogram wire frame 131 on an adjacent bending unit 120 at an opposite corner on the bending vertical line.

In this embodiment, because the first bent part 111 and the second bent part 112 on the unequal parallelogram on the same bending unit 120 are located on different bending parallel lines 114, even if one of the first bent part 111 and the second bent part 112 fractures, a crack does not easily extend to the other one along a material of a substrate 11, thereby effectively lowering the probability that both the first bent part 111 and the second bent part 112 are fractured, and thus effectively alleviating the problems of signal transmission failure and poor display caused by fracture of the wire 100.

In addition, in this embodiment, the first bent part 111 is located at one of the opposite corners of the unequal parallelogram on the bending parallel line, the third bent part 113 is located at the second parallelogram wire frame 132, and the first bent part 111 and the third bent part 113 are located on the same side of the wire 100. Specifically, the wire 100 is divided into two sides along the vertical center line of the wire 100, and the first bent part 111 and the third bent part 113 are located on the same side of the wire 100 relative to the vertical center line. The vertical center line is substantially parallel to the bending vertical line. The first bent part 111 is arranged at the opposite corner on one side of the unequal parallelogram relative to the vertical center line, and the third bent part 113 is arranged at the opposite corner of the second parallelogram wire frame 132 on the same side as the unequal parallelogram. The first bent part 111 and the third bent part 113 are two parts of the unequal parallelogram and the second parallelogram wire frame 132 that bear the largest bending stress on the same side.

Because the third bent part 113 and the first bent part 111 are located on different bending vertical lines 115, a stress on the same bending vertical line 115 during bending of the bent region 10 is reduced, and bending resistance of the wire 100 is improved; and even if one of the first bent part 111 and the third bent part 113 fractures, a crack does not easily extend to the other one along the material of the substrate 11, thereby effectively lowering the probability that both the first bent part 111 and the third bent part 113 are fractured. Therefore, the flexible display panel and the display apparatus can reduce a risk of fracture of the wire 100 during bending of the bent region 10, ensure a signal transmission effect, and effectively alleviate poor display.

In a modified implementation, the first parallelogram wire frame 131 and the second parallelogram wire frame 132 are the same in shape and size and are unequal parallelograms. Each first parallelogram wire frame 131 is provided with the first bent part 111 and the second bent part 112, while each second parallelogram wire frame 132 is provided with the first bent part 111 and the second bent part 112. In this case, the wire 100 does not have the third bent part 113.

In a modified implementation, each bending unit 120 includes a first polygonal wire frame and a second polygonal wire frame (neither shown) that are different in size and connected to each other. The first bent part 111 is located on the first polygonal wire frame, and the third bent part 113 is located on the second polygonal wire frame. The first polygonal wire frame may be triangular, quadrilateral, pentagonal, circular, oval or irregularly polygonal. When the first polygonal wire frame has at least two corners that are not on the same bending parallel line, e.g., when the first polygonal wire frame is an unequal quadrilateral or a pentagon, the first polygonal wire frame is further provided with the second bent part 112. When the first polygonal wire frame is an equilateral quadrilateral, such as a square or an equilateral parallelogram, the wire does not have the second bent part 112.

In conclusion, the parallelogram wire frame in the aforementioned example may actually alternatively be another polygonal wire frame. Specifically, the bending unit 120 may include one or more polygonal wire frames. When the bending unit 120 includes only one polygonal wire frame, the wire 100 includes only the first bent part 111 and the second bent part 112, and does not include the third bent part 113. In this case, the polygonal wire frame may be an unequal parallelogram, a rectangle, a pentagon, an irregular polygon or another polygon which has at least two corners in the extension direction of the bending parallel line, and the two corners are not on the same bending parallel line. When the bending unit 120 includes two or more polygonal wire frames, the bending unit 120 includes at least two polygonal wire frames with different sizes. In this case, the first bent part 111 and the third bent part 113 are located on two polygonal wire frames with different sizes, respectively, and the polygonal wire frames each may be a triangle, a quadrilateral, a pentagon, a circle, an oval, or an irregular polygon. When the polygonal wire frame with the first bent part 111 has two corners in the extension direction of the bending parallel line, and the two corners are not on the same bending parallel line, the polygonal wire frame with the first bent part 111 is provided with the second bent part 112, otherwise, the wire 100 does not include the second bent part 112.

### Second Embodiment

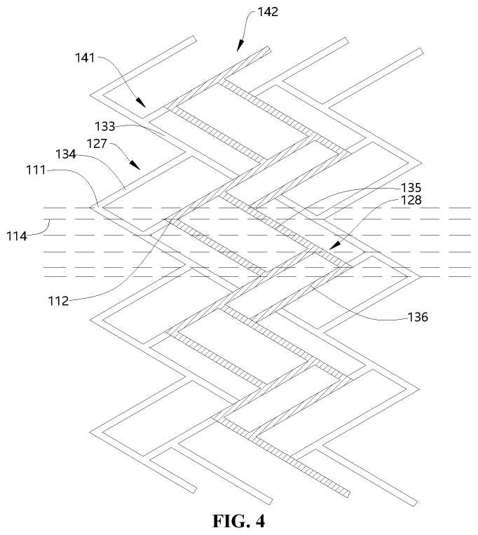

Referring to FIG. 4, a wire 100 of a flexible display panel 1 provided in this embodiment includes a first bent part 111 and a second bent part 112. The second bent part 112 is adjacent to the first bent part 111 in an extension direction of a bending parallel line 114, and the second bent part 112 and the first bent part 111 are located on different bending parallel lines 114. It should be understood that the first bent part 111 and the second bent part 112 are located on the same wire 100 in this embodiment.

The wire 100 may include a first bending unit group 141 and a second bending unit group 142 (indicated by shading in the figure) that are adjacent and connected to each other, and the first bending unit group 141 and the second bending unit group 142 are corrugated.

The first bending unit group 141 may include multiple fifth bending units 127 connected in sequence. Each of the fifth bending units 127 includes a third parallelogram wire frame 133 and a fourth parallelogram wire frame 134 that are different in size and connected to each other. An area of the third parallelogram wire frame 133 is smaller than an area of the fourth parallelogram wire frame 134. A long side of the third parallelogram wire frame 133 partially overlaps a short side of the fourth parallelogram wire frame 134.

The second bending unit group 142 includes multiple sixth bending units 128 connected in sequence. Each of the sixth bending units 128 includes a fifth parallelogram wire frame 135 and a sixth parallelogram wire frame 136 that are different in size and connected to each other. An area of the fifth parallelogram wire frame 135 is greater than an area of the sixth parallelogram wire frame 136. A short side of the fifth parallelogram wire frame 135 partially overlaps a long side of the sixth parallelogram wire frame 136.

The third parallelogram wire frame 133 and the sixth parallelogram wire frame 136 have the same size, and the fourth parallelogram wire frame 134 and the fifth parallelogram wire frame 135 have the same size. A straight line on which a long side of the fourth parallelogram wire frame 134 is located intersects with a straight line on which a long side of the fifth parallelogram wire frame 135 is located.

The fourth parallelogram wire frame 134 of one of the fifth bending units 127 in the first bending unit group 141 is provided with a first bent part 111, and the fifth parallelogram wire frame 135 of the sixth bending unit 128 that is adjacent to the fourth parallelogram wire frame 134 in the extension direction of the bending parallel line 114 is provided with a second bent part 112.

The second bent part 112 is adjacent to the first bent part 111 in the direction of the bending parallel line 114, and the second bent part 112 and the first bent part 111 are located on different bending parallel lines 114. When bending occurs, the first bent part 111 and the second bent part 112 are located on different bending parallel lines 114, which can reduce a stress on the same bending parallel line 114, thereby reducing a risk of fracture of the wire 100 on the same bending parallel line 114.

### Third Embodiment

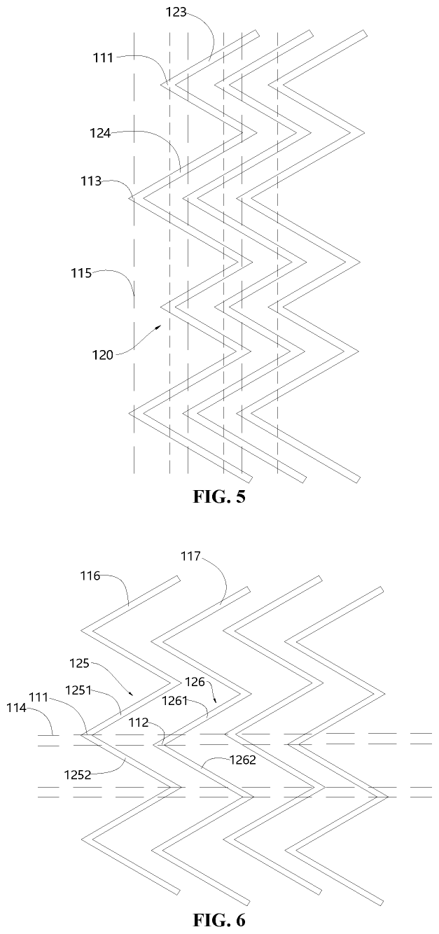

Referring to FIG. 5, a flexible display panel 1 provided in this embodiment is provided with multiple wires 100. The multiple wires 100 are arranged in an extension direction of a bending parallel line and are parallel to each other, each of the wires 100 includes a first bent part 111 and a third bent part 113, the third bent part 113 is adjacent to the first bent part 111 in a direction of a bending vertical line 115, and the third bent part 113 and the first bent part 111 are located on different bending vertical lines 115. It should be understood that, in this embodiment, the first bent part 111 and the third bent part 113 are located on the same wire 100.

In this embodiment, the wire 100 has two sides along a vertical center line of the wire 100, and the first bent part 111 and the third bent part 113 are located on the same side of the wire 100 relative to the vertical center line. The vertical center line is substantially parallel to the bending vertical line 115. Optionally, the wire 100 includes multiple bending units 120 connected in sequence, and the multiple bending units 120 each include a first bending unit 123 and a second bending unit 124 that are adjacent and connected to each other. The first bent part 111 is arranged on one side of the first bending unit 123, and the third bent part 113 is arranged at a part of the second bending unit 124 on the same side as the first bending unit 123. Optionally, there are multiple first bending units 123 and multiple second bending units 124, and the multiple first bending units 123 and the multiple second bending units 124 are sequentially alternately distributed.

It should be noted that the first bent part 111 is a bend position on the first bending unit 123, and the third bent part 113 is a bend position on the second bending unit 124. When the wire 100 is bent, the first bent part 111 and the third bent part 113 are parts that bear the largest stress on the respective bending units 120.

Because the first bent part 111 and the third bent part 113 are located on different bending vertical lines 115, the probability of a crack extending along a material of a substrate 11 during fracture can be lowered, and the risk of fracture of the wire 100 on the same bending vertical line 115 can be reduced.

Optionally, the wire is corrugated, the first bending unit 123 and the second bending unit 124 each are in a “<” shape, and openings of the “<” shapes face the same direction. The corrugated wire 100 has peaks and valleys, and the first bent part 111 and the third bent part 113 are both located at peaks or valleys. On the same wire 100, a distance from the first bent part 111 to the vertical center line of the wire 100 is smaller than a distance from the third bent part 113 to the vertical center line of the wire 100. That is, when the first bent part 111 and the third bent part 113 are both at peaks, the peak at which the third bent part 113 is located has a larger peak value; and similarly, when the first bent part 111 and the third bent part 113 are both at valleys, the valley at which the third bent part 113 is located has a larger depth.

In this embodiment, the first bent part 111 and the third bent part 113 are located at adjacent peaks of the wire 100, and a peak value of the peak at which the third bent part 113 is located may be 1.5-2.5 times a peak value of the peak at which the first bent part 111 is located. Further, the peak value of the peak at which the third bent part 113 is located is twice the peak value of the peak at which the first bent part 111 is located. It should be noted that when the first bent part 111 and the third bent part 113 are both at peaks, all valleys of the wire 100 are flush, i.e., distances from all the valleys to the vertical center line of the wire are equal; and similarly, when the first bent part 111 and the third bent part 113 are at valleys, the valley at which the third bent part 113 is located has a larger absolute value, i.e., a distance from a valley at which the third bent part 113 is located to the vertical center line of the wire 100 is greater than a distance from the first bent part 111 to the vertical center line. In this case, all the peaks of the wire 100 are flush.

### Fourth Embodiment

Referring to FIG. 6, a flexible display panel 1 provided in this embodiment is provided with multiple wires 100. The multiple wires 100 include a first wire 116 and a second wire 117 that are adjacent and spaced. The first wire 116 and the second wire 117 are located at the same trace layer 12. The first wire 116 and the second wire 117 are corrugated and substantially parallel. The first wire 116 is provided with a first bent part 111, and the second wire 117 is provided with a second bent part 112. The second bent part 112 is adjacent to the first bent part 111 in an extension direction of a bending parallel line 114. The second bent part 112 and the first bent part 111 are located on different bending parallel lines 114. The first bent part 111 and the second bent part 112 are both located at peaks or valleys. Optionally, all peaks of the corrugated first wire 116 are first bent parts 111, and all peaks of the corrugated second wire 117 are second bent parts 112; or, all valleys of the corrugated first wire 116 are first bent parts 111, and all valleys of the corrugated second wire 117 are second bent parts 112.

The first wire 116 includes multiple third bending units 125 connected in sequence, and the first bent parts 111 are arranged on the third bending units 125. In this embodiment, the first bent parts 111 are arranged on peaks formed by the third bending units 125. The second wire 117 includes multiple fourth bending units 126 connected in sequence, and the second bent parts 112 are arranged on the fourth bending units 126. The third bending units 125 and the fourth bending units 126 have the same shape and structure, and third bending units 125 and fourth bending units 126 that are adjacent to each other are staggered in the extension direction of the bending parallel line. In this embodiment, the second bent parts 112 are arranged on peaks formed by the fourth bending units 126.

The first bent parts 111 and the second bent parts 112 respectively on third bending units 125 and fourth bending units 126 that are adjacent to each other are located on different bending parallel lines 114. In this way, a stress on the same bending parallel line 114 during bending of the bent region 10 is reduced, and bending resistance of the wires 100 is improved; and even if one of the first bent part 111 and the second bent part 112 fractures, a crack does not easily extend to the other one along a material of a substrate 11, thereby effectively lowering the probability that both the first bent part 111 and the second bent part 112 are fractured, and effectively alleviating the problem that multiple wires 100 fracture due to a crack extending along the material of the substrate 11.

The specific shapes of the third bending unit 125 and the fourth bending unit 126 are not specifically limited. The third bending unit 125 and the fourth bending unit 126 each may be in a “<” shape, or in a parallelogram shape, or in a circle shape, or in an oval shape, or in an irregular shape. In the fourth embodiment, the third bending unit 125 and the fourth bending unit 126 each are in the “<” shape.

Optionally, the third bending unit 125 includes a third bent section 1251 and a fourth bent section 1252, and a joint between the third bent section 1251 and the fourth bent section 1252 is bent to form the first bent part 111. An end of the third bent section 1251 that is away from the first bent part 111 is connected to the fourth bent section 1252 of another third bending unit 125. The fourth bending unit 126 includes a fifth bent section 1261 and a sixth bent section 1262. A joint between the fifth bent section 1261 and the sixth bent section 1262 is bent to form the second bent part 112. An end of the fifth bent section 1261 that is away from the second bent part 112 is connected to the sixth bent section 1262 of another fourth bending unit 126.

The third bent section 1251 and the fourth bent section 1252 each are a straight section, and the third bent section 1251 and the fourth bent section 1252 are connected to form the “<” shape; the fifth bent section 1261 and the sixth bent section 1262 each are a straight section, and the fifth bent section 1261 and the sixth bent section 1262 are connected to form the “<” shape. Directions of openings of the two “<” shapes formed above are parallel to the bending parallel line 114.

### Fifth Embodiment

Referring to FIG. 7, multiple wires 100 of a flexible display panel 1 provided in this embodiment are similar to the multiple wires 100 of the flexible display panel 1 provided in the fourth embodiment, except that shapes of third bending units 125 and fourth bending units 126 in this embodiment are different from those in the fourth embodiment. The third bending units 125 and the fourth bending units 126 have the same shape and structure, and are staggered in an extension direction of a bending parallel line 114. In this embodiment, the third bending unit 125 and the fourth bending unit 126 each are in an oval shape. A third bent section 1251 and a fourth bent section 1252 in the third bending unit 125 each are in an arc shape, and the third bent section 1251 and the fourth bent section 1252 are connected to form a flat oval ring structure. That is, the third bending unit 125 has an oval wire frame structure as a whole, and has an oval through hole. Two joints of the third bent section 1251 and the fourth bent section 1252 are bends of the first wire 116, and two first bent parts 111 are respectively formed at the two joints. The first bent part 111 is a part of the third bending unit 125 that bears the largest bending stress.

Similarly, a fifth bent section 1261 and a sixth bent section 1262 in the fourth bending unit 126 each are in an arc shape, and the fifth bent section 1261 and the sixth bent section 1262 are connected to form a flat oval ring structure. That is, the fourth bending unit 126 has an oval wire frame structure as a whole, and has an oval through hole. Two joints of the fifth bent section 1261 and the sixth bent section 1262 are bends of the second wire 117, and two second bent parts 112 are respectively formed at the two joints. The second bent part 112 is a part of the fourth bending unit 126 that bears the largest bending stress.

The first bent parts 111 and the second bent parts 112 respectively on third bending units 125 and fourth bending units 126 that are adjacent to each other are located on different bending parallel lines 114, and first wires 116 and second wires 117 that are adjacent to each other are staggered, which effectively alleviates the problem that multiple wires 100 fracture due to a crack extending along a material of a substrate 11.

### Sixth Embodiment

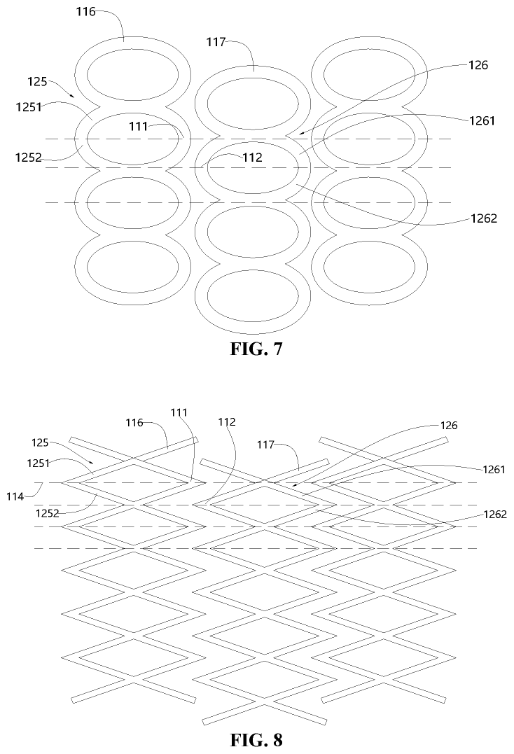

Referring to FIG. 8, multiple wires 100 of a flexible display panel 1 provided in this embodiment are similar to the multiple wires 100 of the flexible display panel 1 provided in the fourth embodiment, except that shapes of third bending units 125 and fourth bending units 126 in this embodiment are different from those in the fourth embodiment. The third bending units 125 and the fourth bending units 126 have the same shape and structure, and are staggered in an extension direction of a bending parallel line 114. In this embodiment, the third bending unit 125 and the fourth bending unit 126 each are in a parallelogram shape. Further, a third bent section 1251 and a fourth bent section 1252 in the third bending unit 125 each are in a fold line shape, and the third bent section 1251 and the fourth bent section 1252 are connected to form a rhombic structure. That is, the third bending unit 125 has a rhombic structure as a whole, and has a rhombic through hole. Two joints of the third bent section 1251 and the fourth bent section 1252 are bends of the first wire 116, and two first bent parts 111 are respectively formed at the two joints. The first bent part 111 is a part of the third bending unit 125 that bears the largest bending stress.

Similarly, a fifth bent section 1261 and a sixth bent section 1262 in the fourth bending unit 126 each are in a fold line shape, and the fifth bent section 1261 and the sixth bent section 1262 are connected to form a rhombic structure. That is, the fourth bending unit 126 has a rhombic structure as a whole, and has a rhombic through hole. Two joints of the fifth bent section 1261 and the sixth bent section 1262 are bends of the second wire 117, and two second bent parts 112 are respectively formed at the two joints. The second bent part 112 is a part of the fourth bending unit 126 that bears the largest bending stress.

The first bent parts 111 and the second bent parts 112 on third bending units 125 and fourth bending units 126 that are adjacent to each other are located on different bending parallel lines 114, and first wires 116 and second wires 117 that are adjacent to each other are staggered, which effectively alleviates the problem that multiple wires 100 fracture due to a crack extending along a material of a substrate 11.

### Seventh Embodiment

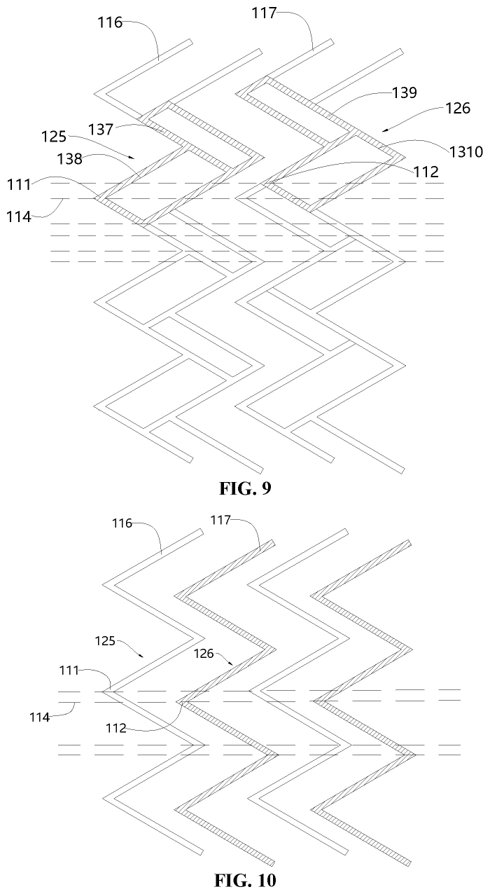

Referring to FIG. 9, multiple wires 100 of a flexible display panel 1 provided in this embodiment are similar to the multiple wires 100 of the flexible display panel 1 provided in the fourth embodiment, except that shapes of third bending units 125 and fourth bending units 126 in this embodiment are different from those in the fourth embodiment. The third bending units 125 (one of the third bending units 125 is indicated by shading in FIG. 9) and the fourth bending units 126 (one of the fourth bending units 126 is indicated by shading in FIG. 9) have the same shape and structure, and are staggered in an extension direction of a bending parallel line 114.

In this embodiment, a first wire 116 and a second wire 117 are corrugated. The third bending unit 125 includes a seventh parallelogram wire frame 137 and an eighth parallelogram wire frame 138 that are different in size and connected to each other, where an area of the seventh parallelogram wire frame 137 is smaller than an area of the eighth parallelogram wire frame 138. A short side of the eighth parallelogram wire frame 138 partially overlaps a long side of the seventh parallelogram wire frame 137.

The fourth bending units 126 each include a ninth parallelogram wire frame 139 and a tenth parallelogram wire frame 1310 that are different in size and connected to each other. An area of the ninth parallelogram wire frame 139 is smaller than an area of the tenth parallelogram wire frame 1310. A short side of the ninth parallelogram wire frame 139 partially overlaps a long side of the tenth parallelogram wire frame 1310.

In addition, the seventh parallelogram wire frame 137 and the ninth parallelogram wire frame 139 have the same size and are staggered in the extension direction of the bending parallel line 114, and the eighth parallelogram wire frame 138 and the tenth parallelogram wire frame 1310 have the same size and are staggered in the extension direction of the bending parallel lines 114.

A first bent part 111 is formed on the eighth parallelogram wire frame 138, and is located on a bending parallel line different from that of a second bent part 112 on an adjacent tenth parallelogram wire frame 1310.

Because the second bent part 112 and the first bent part 111 are located on different bending parallel lines 114, a stress on the same bending parallel line 114 during bending of a bent region 10 can be reduced, and bending resistance of the wires 100 is improved; and even if a fracture occurs, a crack does not easily extend along a material of a substrate 11, thereby effectively lowering the probability that both the first bent part 111 and the second bent part 112 are fractured, and effectively alleviating the problem that multiple wires 100 fracture due to a crack extending along the material of the substrate 11.

### Eighth Embodiment

Referring to FIG. 10, multiple wires 100 of a flexible display panel 1 provided in this embodiment include a first wire 116 and a second wire 117 that are adjacent and spaced. The first wire 116 and the second wire 117 are located at different trace layers 12. In this embodiment, the trace layers 12 include a first trace layer and a second trace layer at different layers, the first wire 116 is arranged at the first trace layer, and the second wire 117 (indicated by shading in FIG. 10) is arranged at the second trace layer. The eighth embodiment is similar to the fourth embodiment except that the first wire 116 and the second wire 117 are located at different layers.

In this embodiment, the first wire 116 and the second wire 117 are corrugated. The first wire 116 is provided with a first bent part 111, and the second wire 117 is provided with a second bent part 112. The second bent part 112 is adjacent to the first bent part 111 in a direction of a bending parallel line 114. The second bent part 112 and the first bent part 111 are located on different bending parallel lines 114.

A projection of the first wire 116 on a surface of a bent region 10 is adjacent to a projection of the second wire 117 on the surface of the bent region 10. That is, although the first wire 116 and the second wire 117 are not located at the same trace layer 12 spatially, the projections of the first wire 116 and the second wire 117 on the surface of the bent region 10 are adjacent.

The first wire 116 includes multiple third bending units 125 connected in sequence, and the first bent parts 111 are arranged on the third bending units 125. The first bent parts 111 are parts of the third bending units 125 that bear the largest bending stress. The second wire 117 includes multiple fourth bending units 126 connected in sequence, and the second bent parts 112 are arranged on the fourth bending units 126. The second bent parts 112 are parts of the fourth bending units 126 that bear the largest bending stress. The first bent parts 111 and the second bent parts 112 on third bending units 125 and fourth bending units 126 that are adjacent to each other are located on different bending parallel lines 114. Optionally, in this embodiment, the third bending unit 125 and the fourth bending unit 126 each are in a “<” shape, and directions of openings of the two “<” shapes formed above are parallel to the bending parallel lines 114.

Because the first bent parts 111 and the second bent parts 112 on third bending units 125 and fourth bending units 126 that are adjacent to each other are located on different bending parallel lines 114, a stress on the same bending parallel line 114 during bending of the bent region 10 can be reduced, and bending resistance of the wire 100s is improved; and even if a fracture occurs during bending, a crack does not easily extend along a material of a substrate 11, thereby effectively lowering the probability that both the first bent part 111 and the second bent part 112 are fractured, and effectively alleviating the problem that multiple wires 100 on different trace layers 12 fracture due to a crack extending along the material of the substrate 11.

In conclusion, in the flexible display panel 1 and the display apparatus provided in the embodiments of the present disclosure, because the second bent part 112 and the first bent part 111 are located on different bending parallel lines 114, a stress on the same bending parallel line 114 during bending of the bent region 10 is reduced, and bending resistance of the wires 100 is improved; and even if one of the first bent part 111 and the second bent part 112 fractures, a crack does not easily extend to the other one along the material of the substrate 11, thereby effectively lowering the probability that both the first bent part 111 and the second bent part 112 are fractured. Because the third bent part 113 and the first bent part 111 are located on different bending vertical lines 115, a stress on the same bending vertical line 115 during bending of the bent region 10 is reduced, and bending resistance of the wires 100 is improved; and even if one of the first bent part 111 and the third bent part 113 fractures, a crack does not easily extend to the other one along the material of the substrate 11, thereby effectively lowering the probability that both the first bent part 111 and the third bent part 113 are fractured. Therefore, the flexible display panel and the display apparatus can reduce a risk of fracture of the wires 100 during bending of the bent region 10, ensure a signal transmission effect, and effectively alleviate poor display.

The above descriptions are merely specific implementations of the present disclosure, and the protection scope of the present disclosure is not limited thereto. Any change or replacement that can be easily figured out by a person skilled in the art within the technical scope disclosed by the present disclosure should fall within the protection scope of the present disclosure. Therefore, the protection scope of the present disclosure should be subject to the claims.

1. A flexible display panel, comprising a bent region, wherein the bent region comprises a trace layer, the trace layer is provided with a wire, and the wire comprises a first bent part and a second bent part adjacent to the first bent part in an extension direction of a bending parallel line, and the second bent part and the first bent part are located on different bending parallel lines, wherein the bending parallel lines are parallel to a bending axis of the bent region.

2. The flexible display panel according to claim 1, wherein the wire comprises multiple bending units connected in sequence, the bending units each comprise a polygonal wire frame, and the first bent part and the second bent part are both located on the polygonal wire frame.

3. The flexible display panel according to claim 2, wherein the polygonal wire frame is an irregular quadrilateral wire frame or a pentagonal wire frame.

4. The flexible display panel according to claim 3, wherein the bending units comprise multiple polygonal wire frames, the polygonal wire frames are quadrilateral wire frames, and at least one of the multiple quadrilateral wire frames is an unequal quadrilateral wire frame or the pentagonal wire frame.

5. The flexible display panel according to claim 4, wherein the unequal quadrilateral wire frame is a parallelogram wire frame or a rectangular wire frame.

6. The flexible display panel according to claim 1, wherein the wire comprises a first wire and a second wire that are adjacent to each other, the first bent part is located on the first wire, and the second bent part is located on the second wire.

7. The flexible display panel according to claim 6, wherein the first wire comprises multiple third bending units connected in sequence, the first bent part is arranged on one of the third bending units, the second wire comprises multiple fourth bending units connected in sequence, the second bent part is arranged on one of the fourth bending units, the third bending units and the fourth bending units have the same shape and structure, and the third bending unit and the fourth bending unit that are adjacent to each other are staggered in the extension direction of the bending parallel lines.

8. The flexible display panel according to claim 7, wherein the third bending units and the fourth bending units each are in a “<” shape, or in a parallelogram shape, or in a circle shape, or in an oval shape, or in an irregular shape.

9. The flexible display panel according to claim 6, wherein the trace layer comprises a first trace layer and a second trace layer at different layers, the first wire is arranged at the first trace layer, and the second wire is arranged at the second trace layer.

10. A flexible display panel, comprising a bent region, wherein the bent region comprises a trace layer, the trace layer is provided with a wire, and the wire comprises a first bent part and a third bent part adjacent to the first bent part in an extension direction of a bending vertical line, and the third bent part and the first bent part are located on different bending vertical lines, wherein the bending vertical lines are perpendicular to the bending axis of the bent region.

11. The flexible display panel according to claim 10, wherein the wire comprises multiple bending units connected in sequence, each of the bending units comprises a first polygonal wire frame and a second polygonal wire frame that are different in size and connected to each other, the first bent part is located on the first polygonal wire frame, and the third bent part is located on the second polygonal wire frame.

12. The flexible display panel according to claim 11, wherein the first polygonal wire frame is an unequal quadrilateral, and the first bent part and the second bent part are located respectively at two opposite corners of the unequal quadrilateral in the direction of the bending parallel line.

13. The flexible display panel according to claim 10, wherein the wire has two sides along a vertical center line of the wire, the vertical center line is parallel to the bending vertical line, and the first bent part and the third bent part are located on the same side of the wire relative to the vertical center line.

14. The flexible display panel according to claim 13, wherein the wire is corrugated and has peaks and valleys, the first bent part and the third bent part are located on adjacent peaks of the wire respectively, and a peak value of the peak at which the third bent part is located is 1.5-2.5 times a peak value of the peak at which the first bent part is located.

15. A display apparatus, comprising a flexible display panel;
the flexible display panel comprising a bent region, wherein the bent region comprises a trace layer, the trace layer is provided with a wire, and the wire comprises a first bent part and a second bent part adjacent to the first bent part in an extension direction of a bending parallel line, and the second bent part and the first bent part are located on different bending parallel lines, wherein the bending parallel lines are parallel to a bending axis of the bent region; or,
the flexible display panel comprising a bent region, wherein the bent region comprises a trace layer, the trace layer is provided with a wire, and the wire comprises a first bent part and a third bent part adjacent to the first bent part in an extension direction of a bending vertical line, and the third bent part and the first bent part are located on different bending vertical lines, wherein the bending vertical lines are perpendicular to the bending axis of the bent region.
